(19) United States
(12) Patent Application Publication
(10) Pub. No.: US 2014/0081798 A1
(43) Pub. Date: Mar. 20, 2014

(54) SYSTEMS AND METHODS FOR PROVIDING A GIFT REGISTRY

(71) Applicant: BED BATH & BEYOND PROCUREMENT CO. INC., Union, NJ (US)

(72) Inventors: Michelle Anne Millstone-Shroff, Summit, NJ (US); Lori Ann Bush, Summit, NJ (US)

(73) Assignee: BED BATH & BEYOND PROCUREMENT CO. INC., Union, NJ (US)

(21) Appl. No.: 13/622,075

(22) Filed: Sep. 18, 2012

(51) Int. Cl. G06Q 30/06

(52) U.S. Cl. CPC G06Q 30/0633
USPC 705/26.7

(57) ABSTRACT

Systems and methods for recommending items for inclusion in a gift registry for a registrant are provided. In various aspects, a processor may receive, over an electronic network, information identifying one or more social sources associated with the registrant. The information identifying the social sources may be used to automatically determine one or more individuals socially associated with the registrant at the respective sources. An invitation may be transmitted to at least one of the determined individuals, requesting the individual to select and recommend at least one item for inclusion in the registrant's gift registry. In one or more aspects, the registrant may accept, ignore, or request additional information regarding items selected and recommended by one or more of the individuals.

### TECHNICAL FIELD

The present disclosure is directed to systems and methods for providing a gift registry.

### BACKGROUND OF THE INVENTION

Many retail merchants provide consumers with the ability to add, update, and purchase desired items in a gift registry. A registrant planning an event such as a wedding, bridal or baby shower, birthday, or any special occasion can register at a registry provider's store or online website to setup a gift registry. Once registered, the registrant can identify and add desired items (or services) to the registrant's gift registry. The desired gifts may be added to the registry by scanning the bar code of physical items at a retail store, or by selecting items by browsing one or more web-pages at a retailer's website.

Once a registry has been created and published by the registrant, purchasers that wish to purchase a gift for the event can then access the registrant's gift registry at a retail store by, for example, providing the name of the registrant to a registry kiosk or registry server or computer. The purchasers can also browse and purchase a gift desired by the registrant at the registry provider's website by connecting with the registry web-site via a network enabled device such as a smart phone, tablet, personal computer or a laptop. The gift registry can keep track of the purchased gifts, thus providing a mechanism for informing the registrant that a particular gift or gifts desired by the registrant have been purchased.

### SUMMARY OF THE INVENTION

The systems and methods disclosed herein advantageously allow a registrant to request and receive recommendations for an on-line gift registry from the registrant's friends, family, and acquaintances using one or more social sources associated with a registrant, such as social networks including Facebook, Twitter, Google+, etc.

In one aspect, a method for soliciting recommendation of items for inclusion in a gift registry for a registrant is provided. The method may include: receiving information over an electronic network identifying a source associated with the registrant; determining, using a processor, one or more individuals associated with the registrant at the source identified by the information; and, transmitting, over the electronic network, an invitation to the source to provide recommendations for one or more items for inclusion in the gift registry to at least one individual selected from the one or more individuals associated with the registrant.

In another aspect, a method for soliciting recommendation of items for inclusion in a first gift registry for a first registrant and a second gift registry for a second registrant is provided. The method may include receiving information over an electronic network identifying a source associated with the first registrant and the second registrant. The method may further include determining, using a processor, an individual associated with the first registrant and the second registrant at the source identified by the information, and, transmitting, over the electronic network, an invitation to the selected individual to provide one or more item recommendations for inclusion in the first gift registry and the second gift registry. The method may also include receiving, over the electronic network, at least one item recommendation selected by the individual for inclusion in the first gift registry and the second gift registry in response to the invitation. Further still, the method may include saving, in a database, the at least one item recommendation selected by the individual in the first gift registry for presentation to the first registrant and, saving, in the database, the at least one item recommendation selected by the individual in the second gift registry for presentation to the second registrant.

In yet another aspect, a gift registry system for managing a gift registry of a registrant is provided. The gift registry system may include a processor and a memory storing one or more instructions executable by the processor. The one or more instructions, when executed by the processor, may configure the processor to: identify a source including information regarding at least one individual connected with the registrant of the gift registry at the source; automatically determine the at least one individual connected with the registrant based on the information obtained from the source; and, transmit an invitation to the at least one individual connected with the registrant based on the information obtained from the source, the invitation including a request to the at least one individual to provide recommendations for items for inclusion in the gift registry for the registrant.

In yet another aspect, a method for receiving and processing recommendations for items for inclusion in a registrant's gift registry is provided. The method may include receiving information regarding one or more individuals selected by the registrant to provide recommendations for items for inclusion the gift registry; receiving, from a given individual, a recommendation for an item for inclusion in the gift registry; receiving information identifying the given individual providing the recommendation; comparing the information identifying the given individual with the information regarding the one or more individuals selected by the registrant; and, when a comparison result from the comparing step indicates that the given individual is one of the one or more individuals selected by the registrant, storing information regarding the item recommended by the given individual in association with the gift registry for presentment to the registrant.

In various aspects, the invitation may include a selectable link to a registry provider's website hosting one or more webpages including information regarding one or more items selectable by the at least one individual for recommendation for inclusion in the gift registry of the registrant. Furthermore, upon selection of the selectable link included in the invitation, information identifying the at least one individual and the gift registry of the registrant may be determined.

In various aspects, at least one recommendation for an item for inclusion in the gift registry may be received, where the recommended item may be selected by the at least one individual in response to the invitation. Information regarding the recommended item may be displayed to the registrant. The registrant may take further action upon the recommended item by providing an indication to accept the recommended item selected by the at least one individual to the registrant's registry. Upon receiving such indication, the recommended item selected by the at least one individual may be added to the registry for the registrant.

In one aspect, the source may be an email account. In this case, the invitation may be transmitted to the at least one individual by transmitting an email including the invitation to an email address of the at least one individual, where the email address of the at least one individual is automatically determined based on the information obtained from the email account.

In another aspect, the source may be a social media network. In this case, the invitation may be transmitted to the at least one individual by transmitting a social media message including the invitation to a social media account of the at least one individual at the social media network, where the social media account of the at least one individual is automatically determined based on the information obtained from the social media network.

### BRIEF DESCRIPTION OF THE DRAWINGS

FIG. 1 illustrates a topology of a gift registry system according to various aspects of the disclosure.

FIG. 2 illustrates an example of registrant information used to create a gift registry.

FIG. 3 illustrates an example of inviting the registrant to receive recommendations for the gift registry.

FIG. 4 illustrates an example of requesting the registrant to select a social source to identify one or more individuals associated with the registrant.

FIG. 5 illustrates an example where the social source selected by the registrant is a consumer device.

FIG. 6 illustrates an example where the social source selected by the registrant is an email account.

FIG. 7 illustrates an example where the social source selected by the registrant is a social media network.

FIG. 8 illustrates an example where the source is manually specified by the registrant.

FIG. 9 illustrates an example of a determined list of one or more individuals from each selected source for further selection by the registrant.

FIG. 10 illustrates an example of an invitation transmitted to a selected individual for requesting item recommendations for the registrant's registry.

FIG. 11 illustrates an example of a notification provided to the registrant upon reception of a recommendation from a selected individual.

FIG. 12 illustrates an example of registry information, including item recommendations, displayed to the registrant.

FIG. 13 illustrates a process flow diagram in accordance with various aspects of the disclosure.

FIG. 14 illustrates an exemplary hardware for implementing the process flow diagram described in FIG. 13.

### DETAILED DESCRIPTION

The foregoing aspects, features and advantages of the present disclosure will be further appreciated when considered with reference to the following description and accompanying drawings, wherein like reference numerals represent like elements. In describing the aspects of the disclosure illustrated in the appended drawings, specific terminology will be used for the sake of clarity. However, the present disclosure is not intended to be limited to the specific terms used, and it is to be understood that each specific term includes equivalents that operate in a similar manner to accomplish a similar purpose.

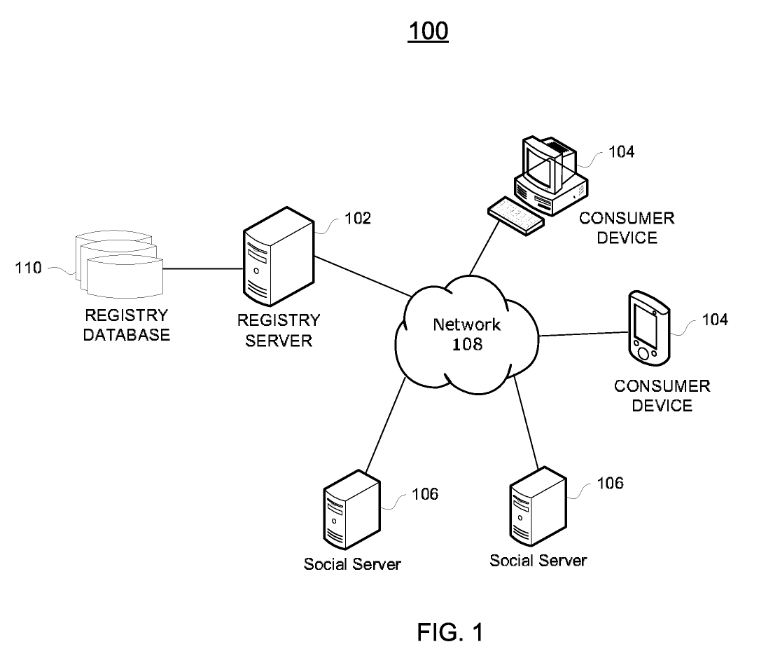

FIG. 1 illustrates one network topology of a gift registry system 100 in accordance with various aspects of the disclosure. As shown, the system 100 may include a registry server 102, one or more consumer devices 104, and one or more social servers 106 that may be communicatively coupled to each other via the network 108. The system 100 may also include a registry database 110 which may be communicatively coupled to the registry server 102 to save, retrieve, and/or update registry information associated with a registrant. Network 108 may comprise the Internet, intranet, or any known type of wired or wireless local-area or wide-area network.

Each of the components of the system 100, such as the registry server 102, the consumer devices 104, and social servers 106, may be one or more general purpose computers or dedicated computing devices executing one or more applications or programs adapted to provide the functionality described further below. Examples of the consumer devices 104 include a kiosk, a Personal Computer (“PC”), a laptop or notebook, a tablet, a cell phone, a set-top box, or a Personal Digital Assistant (“PDA”). The consumer devices 104 may execute a web enabled application, such as the Google's Chrome, Microsoft's Internet Explorer, or the Mozilla's Firefox web browsers, which may display one or more web pages including registry information transmitted to and received from the registry server 102 and/or the social server 106 via the network 108. Furthermore, certain components of the system 100, such as the consumer device 104 and/or the registry server 102, may be accessible from or located at a retailer's physical store location for use by one or more consumers during a visit to the store.

Examples of the registry server 102 and the social servers 106 include a PC, a work station, and/or a mainframe computer, such as the AS/400. The registry server 102 and the social server 106 may execute one or more applications that configure these devices to provide the functionality of, for example, a web server, an enterprise application server, a database server, and/or an email server. While the registry server 102 and the social servers 106 have been illustrated as a single computing device, it will be appreciated that, in other aspects, these servers may be implemented using multiple computing devices. For example, in one aspect the system 100 may include one or more distinct enterprise application servers, one or more web servers, and one or more database servers, which may be communicatively interconnected directly or indirectly over one or more network to provide the functionality of the registry server 102 and the social server 106 as described below.

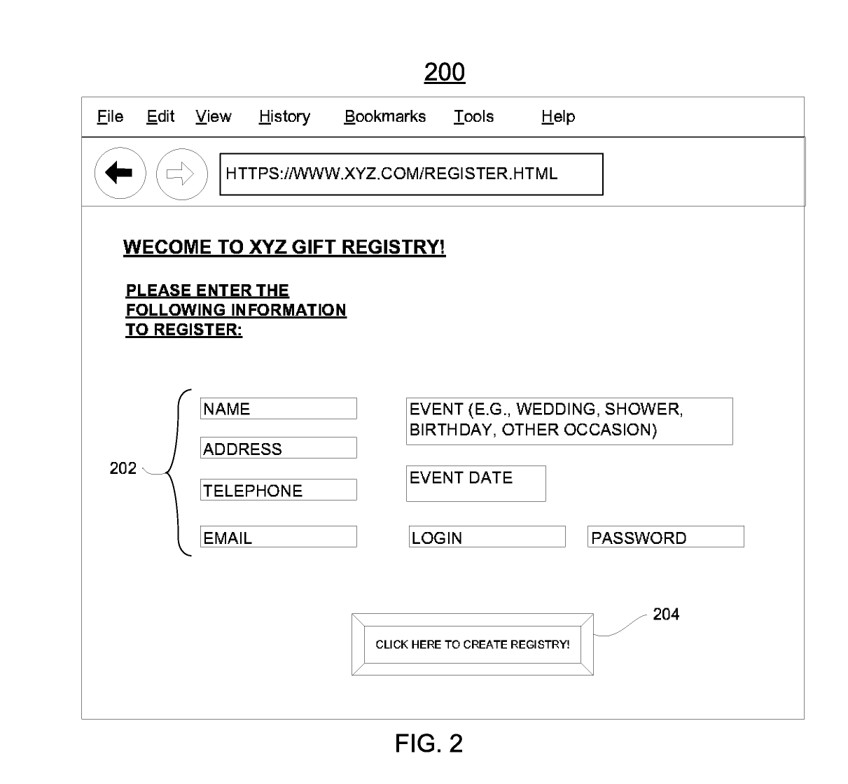

In one aspect, a user planning an event may register with a registry provider, such as, but not limited to, a given retailer. For example, the user may enter a Uniform Resource Locator (“URL”) of a registry provider's website into a web browser running on a consumer device 104. Such action may result in a request being transmitted over the network 108 to a web server, such as the registry server 102, which may be hosted or otherwise provided for the registry provider. In response to the request from the registrant, the registry server 102 may transmit a web page (or web pages) to the web browser on the consumer device 104, in which the registrant may enter information for creating a registry with the registry provider. In general, the requested information may be any type of data desired or required by the registry provider to create a registry. An example of such information is illustrated in FIG. 2 in the form of a webpage 200 received from the registry server 102. As shown, the registrant may enter information 202 such as the registrant's name, address, telephone number(s), email address, etc. into the web page 200. In addition, the registrant may also select a login and a password, which may be used for security and for uniquely identifying the registry. Upon entry of the information 202, the registrant may click on a submit button 204 to transmit the information to the registry server 102 from the consumer device 104.

The registry server 102 may receive, over the network 108, the information 202 provided by the registrant and create a registry based on the information. The registry server 102 may also persistently save the registrant's information and registry data into the database 110 in association with the registrant's login and password information for a given duration of time, such as for the life of the registry or for a period of extended time after the life of the registry. Subsequently, the registry server 102 may transmit one or more additional web pages back to the registrant's consumer device 104 to confirm the creation of the registry and to invite the registrant to take further action.

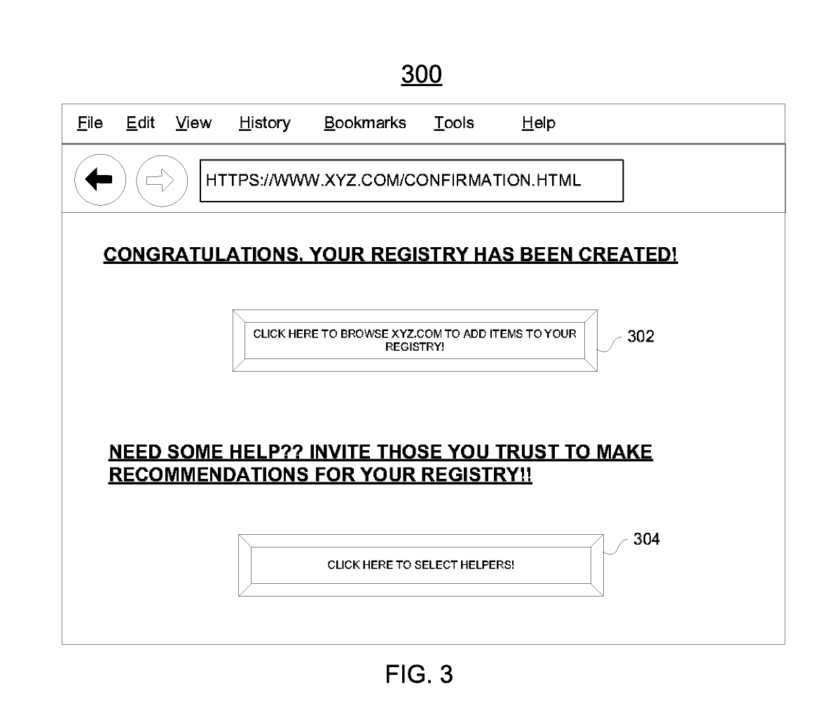

FIG. 3 illustrates an example of a webpage 300 that may be transmitted by the registry server 102 to the consumer device 104 upon the creation of the registry. As shown, webpage 300 may notify the registrant that the registry has been created successfully. Furthermore, webpage 300 may include a link 302, which may be clicked or otherwise activated by the registrant. Activation of the link 302 may result in a request to the registry server 102, which, in turn, may provide one or more webpages which may be browsed by the registrant to select and add items to the registry.

The registrant may not only create and add items to the registry as described above, but may also identify and request help from one or more individuals and/or groups of individuals with respect to populating the registry. For example, the registrant may wish to request help from the registrant's friends, family, co-workers, acquaintances, or any other persons or groups that the registrant trusts and believes would provide helpful advice regarding particular items for the registrant's registry. Such functionality may be particularly advantageous to a registrant planning an event for the very first time. For example, an expectant mother planning a first baby shower may be uncertain or undecided as to which items are particularly useful or “must haves” for the mother and the baby. In this case, enabling the registrant to be able to select trusted individuals known to the registrant that can provide recommendations as to which items should be included based on their own similar experience may be very helpful to the registrant.

Accordingly, and as further shown in FIG. 3, webpage 300 may also include a link 304, which may be activated by the registrant to select and request help from one or more individuals (or groups of individuals) with respect to populating the registry. Indication that the registrant has selected (e.g., clicked upon) the link 304 may be transmitted from the registrant's consumer device 104 to the registry server 102, which may, in response, transmit one or more additional webpages to the consumer device 104 to facilitate providing the registrant with the requested help.

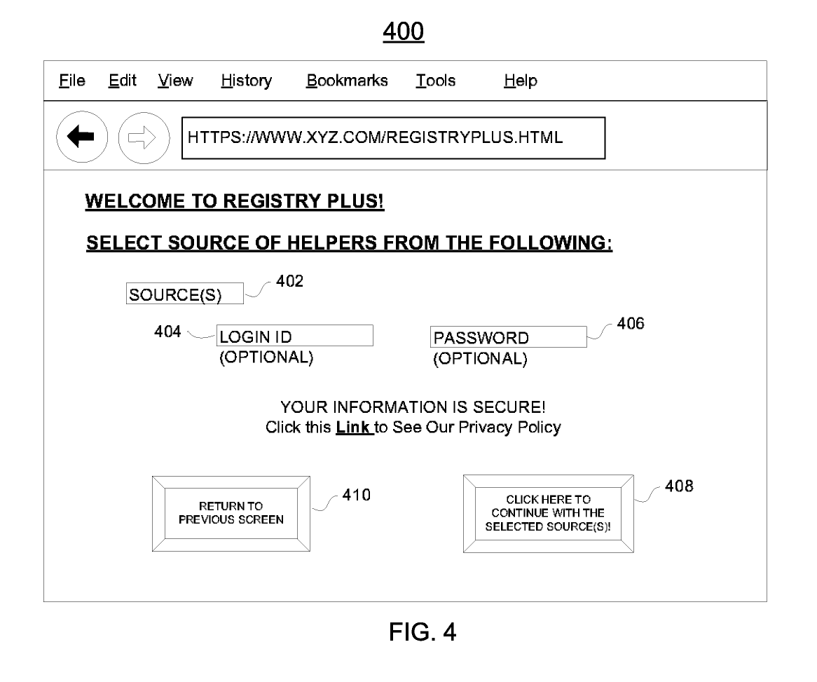

FIG. 4 illustrates an example of a webpage 400 that may be transmitted by the registry server 102 to the consumer device 104 for enabling the registrant to request help from one or more individuals known or trusted by the registrant. As shown, webpage 400 may include a link (or links) 402 for enabling the registrant to select a social source (or sources) from which one or more individuals associated with the registrant may be automatically identified for the registrant. Once the registrant has selected a social source (or sources), and optionally provided login and password information 404, 406 to enable access to each selected source, the registrant may click the link 408 to transmit the source information to registry server 102 from the consumer device 104. In response, the registry server 102 may receive the source information and use it to identify, from each selected source, information regarding one or more individuals or groups of individuals that are associated with the registrant from the respective source. In addition, the registry server 102 may also persistently store the source information provided by the registrant and/or the information regarding the individuals or groups of individuals obtained from the respective source or sources, into the registry database 110 for further processing as appropriate.

To assure the registrant that the social source information will be maintained privately and securely, the webpage 400 may also include a link 410 informing the registrant about the registry provider's privacy and/or security policy. Upon receiving indication that the registrant has clicked upon link 410, the registry server may provide a webpage (not shown) informing the registrant of the steps implemented by the registry provider to maintain the registrant's information securely, such as information regarding encryption protocols and non-disclosure of the registrant's information to third parties for any purpose without express approval of the registrant. Such notice may be helpful to reassure the registrant that the registrant's privacy is being adequately protected, and may encourage the registrant to make the choice to fully utilize the functionality provided by the registry provider with respect to the registrant's registry.

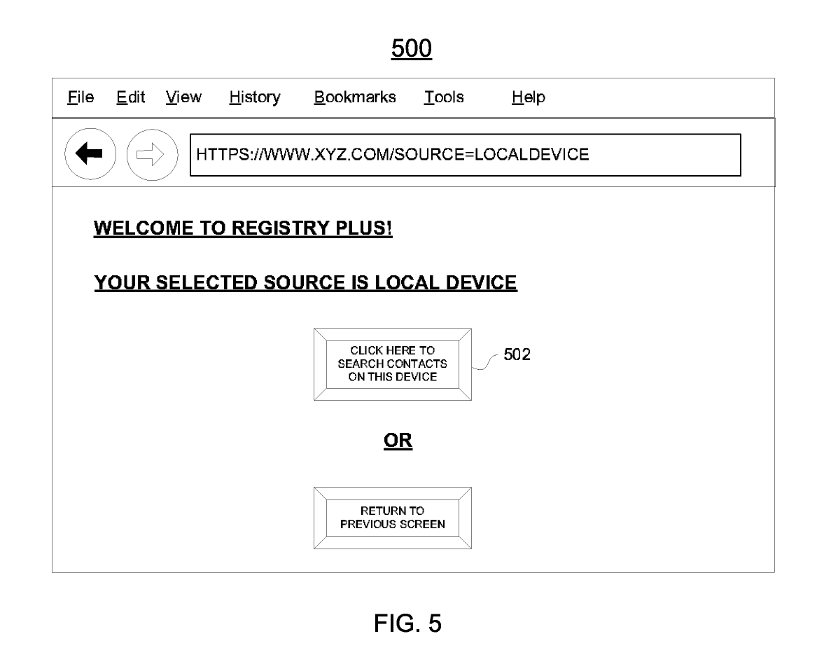

The social source (or sources) 402 that may be selected by the registrant may include a variety of networks, applications, and/or devices. In one aspect the consumer device 104 being used by the registrant may be identified as a social source in the web page 400. In this case, and as shown in FIG. 5, the registration server 102 may provide a webpage 500, which may include a link 502 that may be clicked by the registrant to automatically search and obtain information regarding one or more individuals associated with the registrant from the local device. Accordingly, clicking on the link 502 may start an automatic search for one or more applications (and application data) stored on the local device, such as, by way of example only, contact information stored in the registrant's Outlook email program. The automatic search of the consumer device 104 may be implemented via a script or a program, which, in one aspect, may be provided by the registry server 102 as part of the webpage 500. The script or the program may execute within the web browser in the consumer device upon selection of the link 502. Alternatively, such functionality may be implemented by an external script or a program, which may be activated or downloaded upon selection of the link 502, and which may execute as a standalone script or application on the registrant's consumer device.

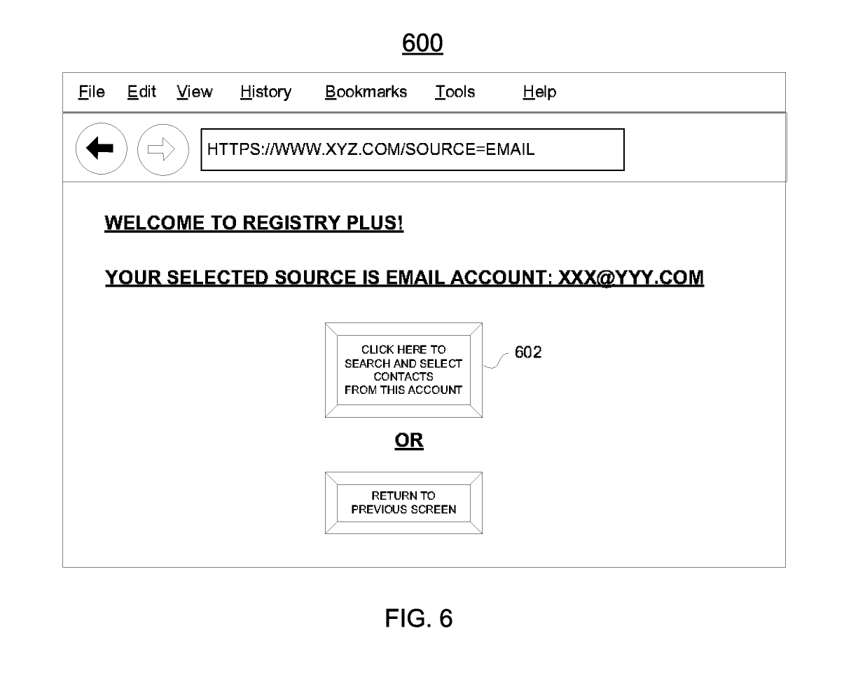

In another aspect, the social source 402 selected by the registrant in the web page 400 may be an external email account (e.g., Hotmail, Gmail, and/or Yahoo Mail). In this case, the registrant may also provide the login 406 and the password 408 for facilitating access to the email account. As shown in FIG. 6, upon receiving indication that the registrant has selected an online email account as the social source, the registration server 102 may provide a webpage 600 to the registrant, that may include a link 602 that may be clicked by the registrant to automatically search and obtain contact information (e.g., name, email address, category, etc.) regarding one or more individuals listed as contacts in the registrant's email account.

After the registrant clicks on the link 602, the registry device 102 may connect, via the network 108, to a social server 106 (which in this aspect may be an email server) hosting the registrant's email account. Upon connection with the social server 106, the registrant's contact list associated with email account may be accessed and searched to identify information regarding one or more individuals (or categories of individuals) included as contacts in the registrant's email account. As before, the registry server 102 may enable such automatic functionality by providing one or more executable scripts or programs, which may remotely login and obtain the contact information associated with the registrant by calling one or more application programming interfaces supported and provided by the social server 106. Such executable scripts and programs may be executed by the registry server 102 as described above, or, alternatively, may be provided to the consumer device 104 for execution within the web browser program on the registrant's consumer device or as an external standalone application. In either event, the registry server 102 may receive information regarding one or more individuals listed as contacts in the registrant's email account, and as before, may persistently save such information in the database 110 in association with the registrant's registry.

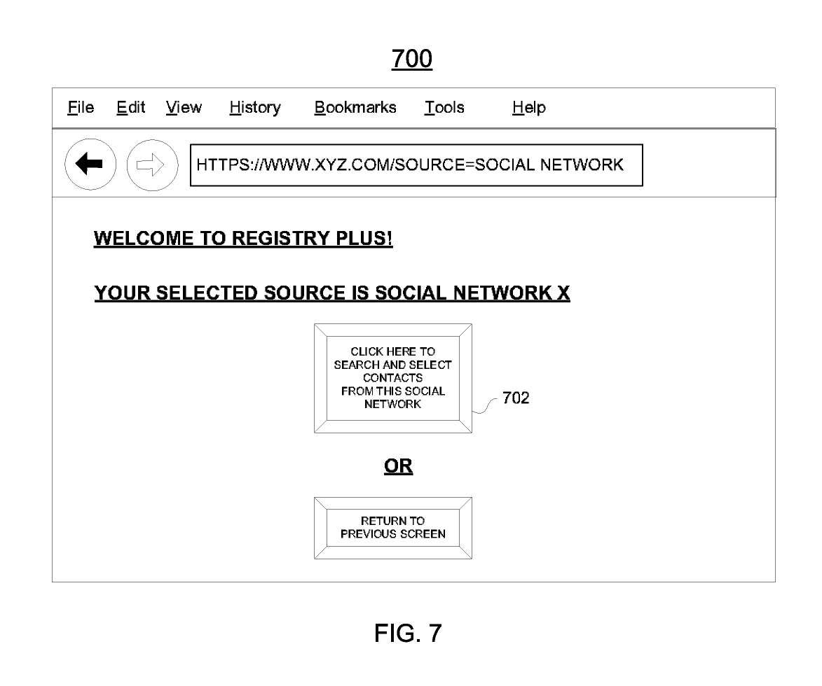

In yet another aspect, the social source 402 selected by the registrant in the web page 400 may be a social network (e.g., Facebook, Twitter, LinkedIn, and/or Google+). In this case, and as with the email account, the registrant may also provide a login 406 and password 408 for facilitating access to registrant's social network account at the selected social network. As shown in FIG. 7, upon receiving indication that the registrant has selected a social network as the source, the registration server 102 may provide a webpage 700 to the registrant, that may include a link 702 that may be clicked by the registrant to automatically search and obtain information regarding one or more individuals that are associated or connected with the registrant at the selected social network, such as for example, Facebook friends, Twitter followers, LinkedIn connections, Google+ groups, etc.

Upon receiving indication that the registrant has clicked 702, the registry device 102 may connect, via the network 108, to a social server 106 for the selected social network, which may be identified based on the registrant's login information or based on other information such as the name or URL of the social network. Upon connection with the social server 106, the registrant's social connections (e.g., friends, colleagues, family members, etc.) within the social network may be identified. Thereafter, the registry server 102 may search the social connections for the registrant and identify one or more individuals connected with the registrant at the respective social network.

As in other cases, the registry server 102 may enable such functionality by providing one or more executable scripts or programs, which, when activated upon selection of the link 702, may remotely login to the social network and obtain the connections associated with the registrant (e.g., by calling one or more application programming interfaces supported and provided by the social server 106). Such executable scripts and programs may be stored and executed by the registry server 102 as described above, or, alternatively, may be provided to the consumer device 104 for execution within the web browser program or for execution as an as an external standalone application on the consumer device. In either event, the registry server 102 may receive information regarding one or more individuals listed as connections in the registrant's social network, and as before, the registry server may also save such information in the database 110 in association with the registrant's registry.

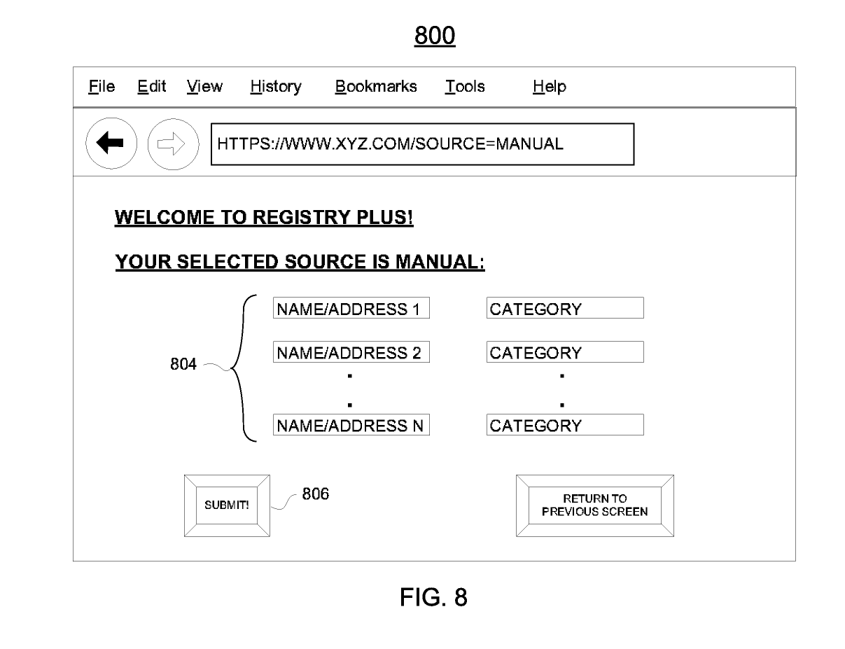

In yet another aspect, the source 402 selected by the registrant in the web page 400 may be manually entered. As shown in FIG. 8, upon receiving indication that the registrant prefers to manually provide information regarding one or more individuals socially associated with the registrant, the registration server 102 may provide a webpage 800 for enabling the registrant to manually provide such information via one or more fields 804 provided on the webpage. For example, the registrant may enter in a name and an address for one or more selected individuals in the fields 804. In one aspect, the address may be an email address of the selected individual. Alternatively, the address may be a physical address, a telephone number, a fax number, a website URL, a blog address, etc. In addition, the registrant may also specify a category for each selected individual in the fields 804. For example, the registrant may specify if the selected individual is a family member, a friend, a co-worker, an acquaintance, or a group or organization. Upon entering information for one or more selected individuals, the registrant may click on the link 806 to submit the information to the registry server 102. The registry server 102 may receive the information provided by the registrant via webpage 800, and, in turn, may save the information in the registry database 110 in association with the registrant's registry for further processing.

While certain aspects for identifying one or more individuals associated with the registrant from one or more social sources have been illustrated in FIGS. 4-8 to enable understanding of the present disclosure, it will be appreciated that the present disclosure is not limited to the particular embodiments disclosed in these figures. Furthermore, the present disclosure is also not limited to any particular “look and feel” of the illustrated webpages, or even to webpages per se.

For example, it is contemplated that, in some embodiments, certain interaction between the registrant and the registration server 102 may be enabled by other means, such as by email, SMS texts, blogs, a custom application, etc. By way of a particular example, instead of providing a webpage 400 to a web browser on the consumer device 102, in other aspects the information depicted in webpage 400 (and/or in other webpages) may be provided by transmitting a hypertext enabled email (or a SMS text) to an email address (or a telephone number) of the registrant. In this case, the registrant may receive the email (or text message), which may include one or more features illustrated in the figures above in the hypertext format, and may take appropriate actions in response to the email (or text message).

It is also contemplated that in some embodiments the information provided by the registrant may be received at a retail store of a retail merchant hosting the registry. For example, the registrant may provide information for registering with the retail merchant at the retail store to a registry representative. Furthermore, the registrant may also provide information identifying one or more individuals selected by the registrant for providing recommendations for items for inclusion in the registry to the registry representative at the retail store. A gift registry representative may receive information provided by the registrant at the retail store and enter it into a computer/server located at the retail store, which as described above, may be the registry server 102 or a consumer device 104 interconnected to the registry server 102 via the network 108.

In one embodiment, the registry server 102 may receive information from the registrant regarding one or more social sources (including login information as appropriate), and may use such information to automatically identify information regarding one or more individuals connected with the registrant from each respective social source. The information obtained regarding one or more individuals associated with the registrant in each of the sources may include, for example, the individual's name, relationship to the registrant (e.g., friend, family, co-worker, etc.), contact information (specific to the particular source and/or general), such that the registrant may then select particular individuals identified from the social sources to that the registrant trusts or believes will provide best recommendations for the registry.

In addition, in one or more of the embodiments disclosed above, the webpages provided by the registry server may allow the registrant to select or restrict particular categories of individuals that are identified from the selected sources. By way of example only, the registrant may select or restrict individuals by categories such as friends, family, or co-workers. The categories may be presented to the registrant in a pre-populated list of choices (not shown) in the webpage 700, and upon receiving the registrant's input, the registry server 102 may appropriately screen individuals from the selected social network based on the selected (or restricted) categories.

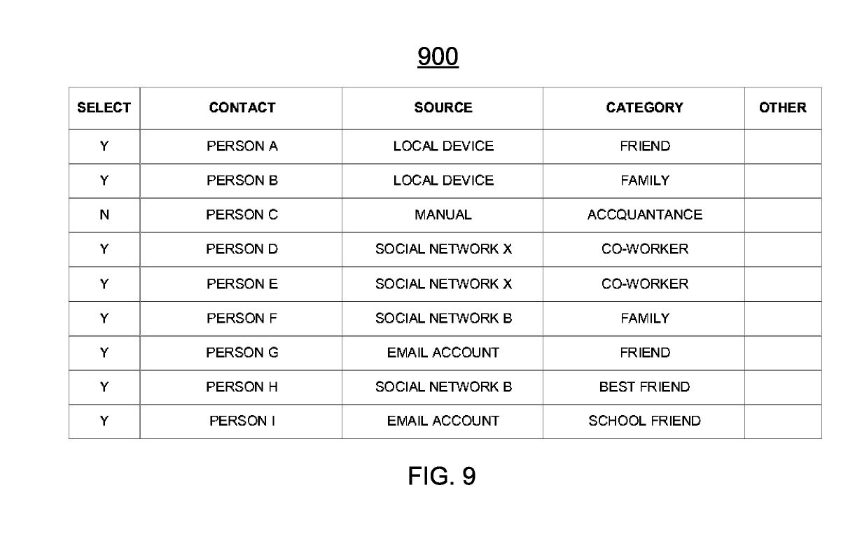

Regardless of the social source or sources from which information regarding individuals (or groups of individuals) associated with a registrant is aggregated, the registry server 102 may present the information to the registrant for further selection in a webpage. The information that may be presented is illustrated in the form of a table 900 in FIG. 9.

As seen in FIG. 9, the social information collected from the one or more sources may be organized and displayed in various ways, such as by name, by category (e.g., relationship to the registrant), by the respective source from which the information was collected, or in no particular order. Furthermore, while particular fields of information are illustrated in table 900, in other embodiments less or more information may also be displayed. Thus, an individual's image (if obtained from, for example, a social network), current or previous status (idle, active, etc.), one or more telephone numbers, or any other relevant information regarding one or more individuals may be included in the table. In one embodiment, information regarding all individuals identified from the social sources may be included in the table. In other embodiments, information regarding fewer individuals may be presented, based on, for example, an indication by the user to restrict the information to a particular category (e.g., co-workers).

The registrant viewing the information illustrated in table 900 (in a webpage for example) may select (or deselect) individuals by name, by category, by source, etc. In the table 900, this selection process is exemplarily illustrated via the “SELECT” field with a “Y” indicating individuals selected by a registrant and an “N” indicating individuals that the registrant does not wish to select for whatever reason. In one embodiment, the registrant may also select (or deselect) all individuals by, for example, choosing a “Select All” or “Deselect All” option during the selection process. Yet further, the individuals may be presented in a default state where all individuals are already selected (or unselected) prior to further selection/modification by the registrant. After completion of the selection process, the registrant may provide this information to the registry server 102 by, for example, clicking a submit button in a webpage in which table 900 is presented.

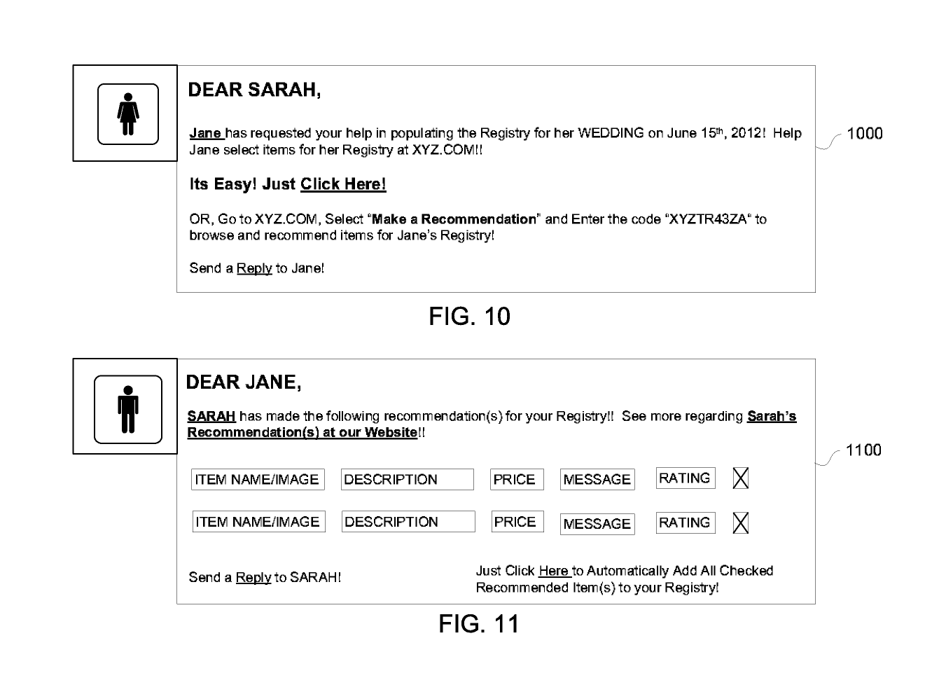

Upon receiving the registrant's selections, the registry server 102 may invite or request each of the selected individuals to provide registry recommendations to the registrant. In a particular aspect, the selected individuals may be invited to provide recommendations at the respective social source from which information regarding the selected individuals was obtained. This is illustrated in FIG. 10, which shows an invitation or request 1000 transmitted in the form of a social network message to a selected individual's (“Sarah”) account at a social network (e.g., Facebook) from which the selected individual's information was collected. As further shown in FIG. 10, the invitation 1000 may include a personal message 1002 (created by the registrant or automatically generated by the registry server 102) informing the selected individual that the registrant has requested his/her recommendation(s) for the registry. The invitation 1000 may also include directions 1004, which may include information necessary for the selected individual to provide recommendations to the registrant, such as the name of the registry provider hosting the registry, the registry provider's website (including a link to the registry provider's website at the registry server), and/or a code that may be entered by the selected individual to enable the registry server 102 to uniquely associate the individual's recommendations with the registrant's registry. For example, the code may be an email address of the registrant, the email address of the selected individual, registry id of the registry, or any other information.

Alternatively, the invitation 1000 may simply include a link (or links), which, when acted upon by the selected individual at the social source, may uniquely identify the selected individual and one or more registries to the registry server. Furthermore, the selected individuals of a social network that receive the invitation may also perform local social network activities (e.g. like, comment, etc.) with respect to the invitation as supported by the social network regardless of any requested action by the selected individuals with respect to the registry.

The manner in which the invitation (or invitations) 1000 is transmitted by the registry server 102 to the selected individual may vary by the source. If the source is a social network such as Facebook, Twitter, or Google+, the invitation 1000 may be a message to the selected individual in the particular format supported by the source. For example, where the source is a social network such as Facebook or Google+, the invitation 1000 may be posted on the selected individual's wall in the registrant's name, or may be transmitted as a personal message from the registrant to the selected individual at the respective source as described above. Similarly, where the source is a social network such as Twitter, the invitation 1000 may be tweeted to the selected individual from the registrant. If the source is an email address manually entered by the registrant or obtained from the registrant's local device, the invitation 1000 may be sent to the selected individual's email address in the form of an email. While particular examples of invitations are described above, it will be understood that the disclosure is not limited to any particular type or format of invitation. For example, in various aspects the invitation may be posted on the selected individual's blog, transmitted as an SMS message, or even physically mailed to the selected individual, regardless of the social source from which the individual connection to the registrant was identified.

Each selected individual may provide one or more recommendations for one or more registries in response to one or more invitations. For example, a selected individual may browse the registry provider's website, select an item, and recommend the item for one or more registries by providing, for example, one or more codes received in an invitation. The registry server 102 may receive and persistently store information regarding the recommended items in association with each registrant's registry into database 110 for the life of the registry or for any suitable period of time.

Furthermore, it will be appreciated that the selected individual need not provide all item recommendations in response to the invitation at any one time. In one aspect, for example, it is envisioned that the selected individual may make one or more further recommendations for a registrant's registry at different times (and/or in response to different invitations) by either visiting the registry provider's website more than once, or by clicking on a link provided on the invitation 1000 more than once and at different times.

Yet further, it is also envisioned that selected individuals may provide recommendations for items for inclusion in one or more registries during a visit to a retail location of the registry provider. For example, a given individual may visit a nearby store and identify one or more registries for which the individual has been invited to provide recommendations. The selected individual may then use a scan gun to select one or more items, and information regarding the scanned items may be received by the gift registry server and saved as recommendation information in each of the one or more registries identified by the recommending individual. In another aspect, a gift registry representative may request information that identifies a registrant's registry (e.g., registrant's name) and the given individual (e.g., name, address, etc.), and then validate that the individual providing the recommendations is one of the one or more individuals selected by the registrant. Upon such validation, the information regarding the items recommended by the given individual for each validated registry may be transmitted to the registry server 102 and persistently stored in association with each registrant's registry for further presentment to the registrant(s) as described above.

While a particular embodiment of the invitation 1000 is depicted in FIG. 10, the disclosure is not so limited. In an alternate aspect, a selected individual may receive an invitation or invitations 1000 to provide recommendations for more than one registry from the registry server 102. This may occur, for example, where registrants of two different registries identify the same individual to provide recommendations for their respective registries. In this case, an invitation 1000 transmitted by the registry server to the selected individual may notify the selected individual that item recommendations are requested for multiple registries and by identifying each registrant individually. In this case, the invitation 1000 may further facilitate providing one or more item recommendations by the selected individual to each respective registry for which the individual recommender has been selected. In alternate embodiments, different invitations may be sent at different times to the recommender for each different registry for which recommendations are desired.

For example, a selected individual may respond to the invitation 1000 to provide recommendations for multiple registries by simply clicking on a link provided on the invitation to connect or navigate to the registry provider's website, and by selecting a set of item or items from one or more webpages hosted by the registry provider's website. In this case, the registry server 102 may be configured to automatically identify the individual making the recommendations (e.g., based on particular information received by the registry server when the selected individual clicks on the link provided in a particular invitation to that individual). The registry server may then receive information regarding the items recommended by the selected individual based on the individual's activity on the registry provider's website, which may be hosted by the registry server or one or more other servers interconnected via a network to the registry server. The registry server may then automatically store the set of recommended item or items in each respective registry for which the individual recommender has been selected for presentation to the respective registrant. Recommending individuals may also be allowed to provide information about themselves that can be used to market other products or services to each of those individuals. In a preferred embodiment, such individuals may be prompted to opt-into such marketing efforts. Further, this and other aspects of the present invention applies in the context of a registry, as well as in the case of a shopping or wish list not tied to a particular event.

In a further aspect, one or more webpages may be presented to the selected individual in response to selection of recommended items such that the selected individual may choose particular items for recommendation to one or more particular registries but not other registries. In this manner, the selected individual may further customize item recommendations for each respective registry for which the individual recommender has been selected. For example, the registry server may create a recommender account for saving items selected by a recommending individual persistently in the registry (or another) database. The recommending individual may then access the account at any time to view, modify, delete, or add items to the account for eventual recommendations to one or more registries selected by the individual. This aspect also advantageously allows a selected individual to make future recommendations to new or additional registries based on items that may have been selected and recommended in the past to another registry.

In one aspect, the recommender account created by the registry server may be used by a selected individual to recommend items available at external sources other than a website or store of a given registry provider. Such functionality may be enabled, for example, by providing a downloadable add-on component for installment in one or more web-browsers preferred by the selected individual. Upon installment, the add-on component may permanently or temporarily display a button, link, icon, or menu item in the preferred browser for activating the add-on component. The selected individual may then activate the add-on component when viewing items displayed in one or more webpages of any website, and the add-on component may be configured to parse information contained in the web-pages to identify an image, description, price, quantity, and/or source of one or more items displayed in the webpage. The recommending individual may then use the add-on component to select one or more identified items for addition to the recommender account. As before, the registry server 102 may receive and persistently store information regarding the recommended items in association with each registrant's respective registry into the database 110.

In one embodiment, the registry server 102 may notify the registrant when a selected individual recommends an item or items for the registry. For example, and as shown in FIG. 11, the registry server 102 may transmit a notification 1100 to the registrant (“Jane”) upon receiving a recommendation or recommendations from a selected individual (“Sarah”). As with the invitation, the notification may be presented to the registrant in a number of ways. In one aspect, for example, the notification 1100 may be a social network message posted to the registrant on a particular social network source (e.g., Facebook, Google+) associated with the registrant. Alternatively or in addition, in other aspects the notification may be tweeted, emailed, or sent as an SMS message to the registrant. Yet further, the notification may also be displayed to the registrant in a webpage when the registrant logs into the registry at a registry provider's website.

As shown in FIG. 11, the notification 1100 transmitted to a particular social source (e.g., Facebook) may include a link inviting the registrant to log into or visit the registry provider's website to view the recommendation(s) provided by the selected individual. Alternatively or in addition, the notification may include information regarding the recommended item(s), such as the item's description, image, price, quantity, consumer rating, and/or a message from the selected individual to the registrant regarding the recommended item or items, etc. Further still, the notification 1100 may also include one or more checkboxes next to each recommended item, which, as shown, may be checked by default such that the registrant may simply single click on a link (shown on the bottom right of the notification) to automatically and advantageously add the checked recommended items to the registrant's registry without requiring the registrant to login at the registry website or take any other action. Furthermore, the registrant may also uncheck one or more of the checkboxes to omit adding particular recommended items to the registry prior to clicking upon the link. Yet further, the notification may also include an additional link (shown on the bottom left of the notification) for enabling the registrant to respond to the selected individual at the same or different social source regarding one or more of the item recommendation(s).

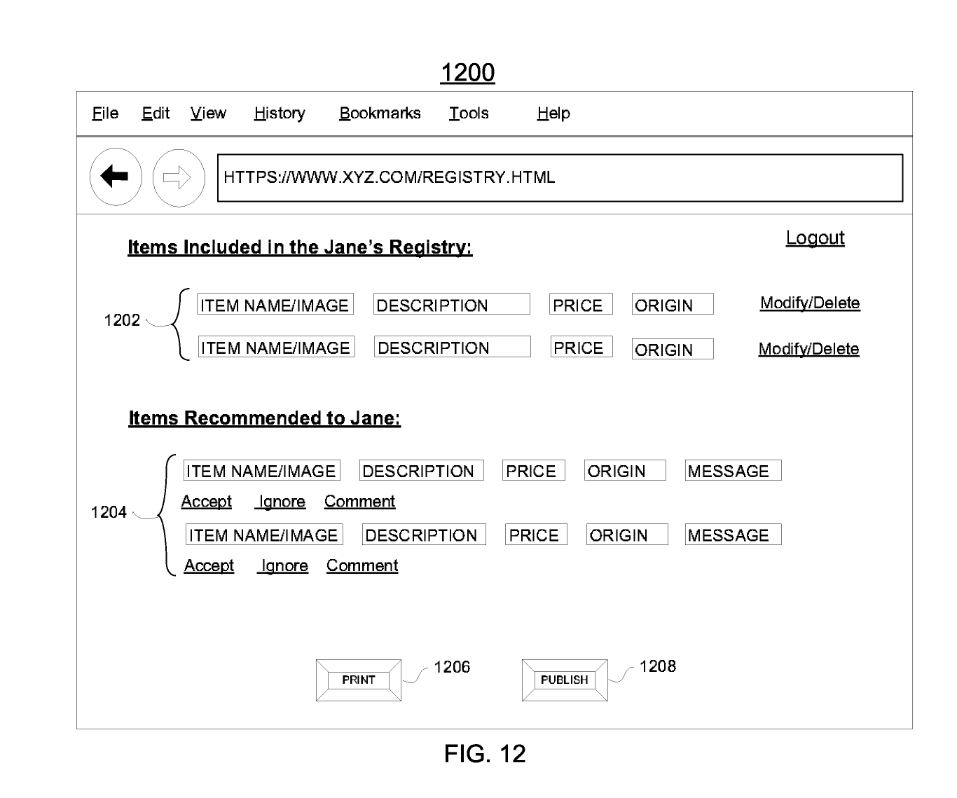

At any time before, during, or after the above described process, the registrant may visit the registry provider's website and log in to view, maintain, or update the status of the registry. Thus, in one aspect the registry server 102 may provide a webpage including the registry information stored in the database 110 to the registrant upon request. FIG. 12 illustrates an example of webpage 1200 that exemplarily illustrates registry information provided to the registrant. As shown in FIG. 12, the registry information may include accepted item information 1202 regarding a list of one or more items currently selected or accepted in the registry (“registry items”). The item information 1202 may include, for example, the name and/or image of a registry item, the description of the registry item, the price of the registry item, etc. More (or less) information about the one or more registry items may also be displayed, such as the color, quantity (desired and/or actual), ratings/reviews, availability, SKU number/barcode, and/or a webpage link to the item.

In addition to the foregoing, the item information 1202 may also identify the origin of the registry items. For example, where a registry item is one that was recommended by an invited individual associated with the registrant, the origin may identify the individual that recommended the item. In other aspects, the origin may also identify the social source (e.g., email account or social network) from which information associating the invited individual with the registrant was obtained. Registry items which were not originally recommended by an invited individual, but were selected and added to the registry by the registrant without any recommendation, may omit the origin information or may simply identify the registrant in the origin information. Further, the item information 1202 may also include one or more links, which may be activated by the registrant to take an action on a registry item, such as a “delete” link to remove an accepted item from the registry and/or a “modify” link to change an aspect of the accepted item (e.g., quantity, color, etc.) included in the registry.

In one aspect, the webpage 1200 may also include recommendation information 1204. In an alternative embodiment, a webpage link to the recommendation information 1200 may be provided instead. The recommendation information 1204 may include information regarding items recommended for the registry by the one or more selected individuals associated with the registrant. As shown in FIG. 12, the recommendation information 1204, like the item information 1202, may include a recommended item's name and/or image, description, price, etc. As before, more (or less) information about the one or more recommended registry items may also be displayed, such as the color, quantity, ratings/reviews, availability, SKU number/barcode, and/or a webpage link to the item. In addition to the foregoing, the recommended information 1204 may also identify the origin of the recommended items. For example, the origin information for a recommended item may identify the particular individual or group of individuals that recommended the item. The origin information of the recommended items may also identify the social source (e.g., email account or social network) of the recommending individual. In addition, the recommendation information 1204 may include a message, where the message may be a personal message regarding the recommended item from the recommending individual to the registrant. In this manner, the registrant may be able to collectively and advantageously evaluate the items recommended by the one or more selected individual's and the reason for the recommendations.

In addition to the foregoing, the recommendation information 1204 may also include one or more links that may be activated by the registrant to take an action on a recommended item. For example, the registrant may choose to “accept”, “ignore”, or “comment” on a recommended item. Accepting a recommended item may result in the addition of a specified quantity of the item to the registry. It may also result in transmission of an acceptance message that the registrant has accepted a particular recommended item or items. The acceptance message may be transmitted to the individual that recommended the accepted item and to one or more other individuals associated with the registrant, such as friends, family, or everyone invited by the registrant to provide recommendations. Ignoring the item may result in removing the item without addition of the item in the registry. Commenting on an item may enable the registrant to remark upon or ask additional questions regarding the item to a recommending individual or to one or more other selected individuals. For example, clicking upon the comment link may enable the registrant to enter a message to the recommending individual (and/or to other selected individuals), that may then be transmitted to each individual at a respective social source. Thus, the registrant may interactively communicate with any of one or more selected individuals regarding one or more recommended items. The messages transmitted between the registrant and one or more individuals may be collected and displayed as part of the recommendation information 1204.

Once the registry is populated with one or more items desired by the registrant, i.e., a registry list of items chosen by the registrant including recommended items accepted by the registrant is ready, the registry may be printed by clicking on the link 1206 and/or published by clicking on the link 1208. Alternatively, the publication of the registry may occur in real time on an item-by-item basis, such that every time an item is added, accepted, removed or updated in the registry, the registry may be published in real time to immediately reflect the changes to the registry. Upon publication of the registry, one or more gift purchasers wishing to purchase items for the registrant may request a list of the published items (by providing the registrant's name, for example) and purchase one or more of the published items at the registry provider's website or at the registry provider's store, or at other retail websites or stores in a conventional manner. In addition, the registry server may receive and save information regarding the published and purchased items in the database 110, and may provide this information to the registrant by, for example, displaying the published and/or purchased items in webpage 1200, displaying the published and/or purchased item in one or more additional webpages, or by periodically mailing, emailing, or posting the list of published and/or purchased items to a social source associated with the registrant. In addition, the registrant may login to the registry provider's website and add, update, or remove items from the published registry at any time. Further still, some or all information described in the various embodiments above, such as the selected social sources and recommending individuals including their corresponding recommendations, may be maintained for the registrant's account for life of registry, such that a registrant may view a complete history and timeline of all events with respect to accepted or recommended items in the registry.

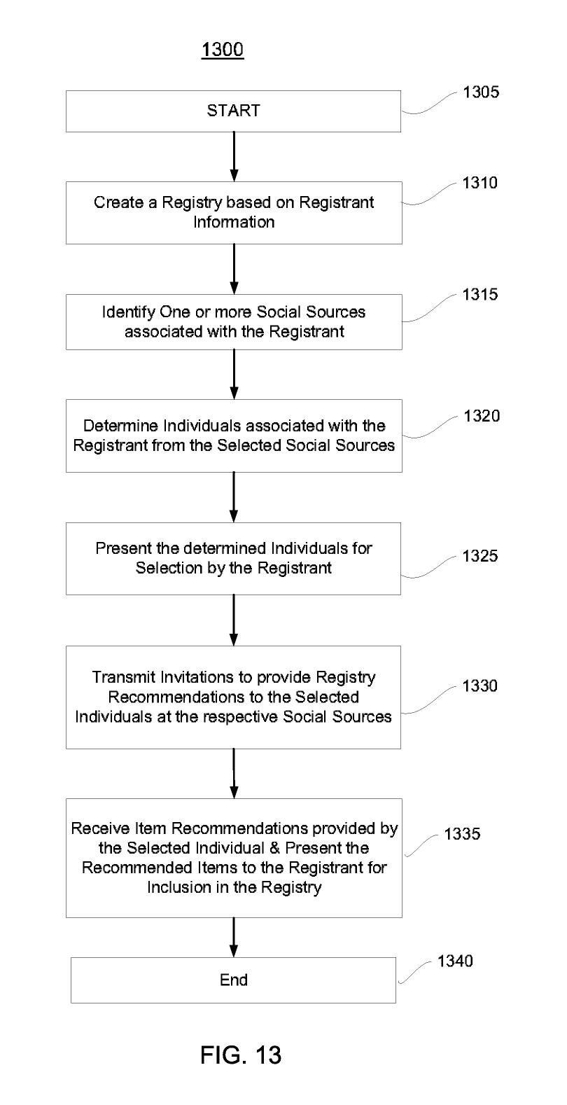

A process in accordance with various aspects of the disclosure is illustrated as flow diagram 1300 in FIG. 13. The following operations do not have to be performed in the precise order described below. Rather, certain operations can occur in a different order or simultaneously.

The process begins in block 1305. In block 1310, the process may include creating a registry based on registrant information provided by a registrant. For example, a registrant may provide personal information, such as the registrant's name, contact information, event information, login information, etc., via a web-enabled consumer device communicatively coupled to the registry provider's server over an electronic network such as the Internet. The server may receive the registrant information over the electronic network and create a registry associated with the registrant based on the received information. The server may also save the registrant's information and information regarding the newly created registry in a database communicatively coupled to the server.

In block 1315, the process may include identifying one or more social sources associated with the registrant. For example, the server may provide the registrant with an option to request item recommendations for the registry from one or more known and/or trusted individuals by selecting one or more social sources associated with the registrant. In various aspects, the identified social sources may include, without limitation, a social network (e.g., Facebook, Twitter, or Google+), a consumer device (e.g., cell phone, personal computer, tablet, or laptop), a local or external email application (e.g., Outlook, Hotmail or Gmail), or a blog or webpage associated with registrant. In addition, the registrant may also provide, and the server may also receive, login information for the registrant at one or more of the identified social sources.

In block 1320, the process may include identifying one or more individuals that are associated with the registrant at each respective selected source. For example, a server may execute, or provide for execution to the consumer device, a script of a program which may be configured to communicate with each selected source over the electronic network and determine one or more individuals associated with the registrant. Where a selected source is a social network, the script or the program may login on the registrant's behalf over the electronic network to a server hosting or providing access to the social network and automatically determine one or more individuals that are connected with the registrant at the social network. The connected individuals may be categorized, without limitation, as the registrant's friends, co-workers, family, acquaintances, etc. The categories may be obtained from the social source.

Where a selected source is an email account, the script or the program may login to an email server hosting the email account over the electronic network and automatically determine one or more individuals that are listed as contacts of the registrant. Where a selected source is a registrant's consumer device (or an application on the consumer device), the script or the program may automatically search one or more memories of the consumer device to identify data containing information regarding one or more individuals associated with the registrant. Furthermore, in one aspect, the registrant may also manually identify one or more individuals by, for example, an email address, a blog address, or a website, and such information may be used to determine one or more individuals associated with the registrant. In all cases, the server may receive the information from each selected source identifying individuals associated with the registrant. The server may also save the information regarding the individuals obtained from each selected source in the database as part of, or in association with the registrant's registry.

In block 1325, the process may include presenting a list of the identified individuals for further selection by the registrant. For example, the server may provide the list of the identified individuals to the registrant in a web page displayed on the consumer device. The displayed list may identify information obtained from each selected source regarding the individuals, such as their name, relationship to the registrant, the source from which the individual was identified, an image of the individual (where available) etc. The registrant may thus select one or more individuals that the registrant believes will provide helpful item recommendations to the registrant. The registrant may also restrict or filter the selection based on, for example, the source or the relationship to the registrant. The registrant's selections may be received by the server and saved in the database as part of, or in association with the registrant's registry.

In a further aspect, the list of identified individuals presented to the registrant may also identify same (e.g., duplicate) individuals associated with more than one social source. For example, the server may identify to the registrant that information regarding the same individual was obtained from two different social sources (or even obtained twice from the same source). This may happen, for example, where a particular individual is associated with the registrant at multiple social networks, is listed in multiple email accounts, or is listed twice in a same email account. In this case, the registrant may choose to select the same individual with respect to each source, or may elect the individual with respect to one or more of the sources but not the other remaining sources.

In block 1330, the process may include transmitting invitations, over the electronic network, to the selected individuals to recommend one or more items to the registrant's registry. As noted above, enabling one or more trusted individuals to provide item recommendations may be particular helpful where the registrant is planning a certain event for the first time.

For example, upon receiving the registrant's selections from block 1325, the server may transmit an invitation to each selected individual at the respective social source from which the individual's association with the registrant was determined. Where the social source is a social network such as Facebook, the server may post a message on the individual's wall on behalf of the registrant. The message may notify the individual that the registrant has requested help with the registry. The message may also include information that enables the invited individual to make recommendations, such as a link to the registry provider's website and a code for associating the recommended items with the registrant's registry. Alternatively or in addition, where the social source is an email account, the server may transmit message in an email to the individual. Similarly, where the social source is a messaging service such as Twitter, the message may be tweeted to the individual.

It will be appreciated that the manner in which a message inviting the selected individual to provide recommendations for the registry is not restricted to any particular source or format. Rather, once individuals associated with the registrant are determined from one or more social sources as described above, the invitation itself may be presented in an email, in a social network message, in a voicemail, in a fax, in an SMS text, in a blog post, in a webpage, or any combination of the foregoing. In one aspect, the invitation may also be mailed to a physical address of the individual.

In block 1335, the process may include receiving, from one or more of the selected individuals, information regarding one or more items recommended for the registrant's registry. For example, the selected individuals may visit the registry provider's website and browse and select items for recommendation for the registry. The server, which may also host the website (or may be communicatively coupled to another server hosting the website), may receive information entered by the selected individuals at the website regarding the recommended items, along with a code, which enables the server to particularly associate the recommended items with the registrant's registry. In addition, the selected individuals may also enter a personal message regarding the recommended items to the registrant, which may also be received by the server. Yet further, the server may also receive information particularly identifying each selected individual providing the recommendations, including information identifying social sources associated with the selected individual. In one aspect, the information regarding the selected individual may be ascertained from the particular code provided to the individual in block 1330. Alternatively, such information may also be entered by the selected individual at the registry provider's website. In all cases, the server may save all such information regarding the recommended items in the database as part of, or in association with, the registrant's registry.

In addition, the process in block 1335 may also include presenting the information regarding the recommended items from each selected individual to the registrant. For example, the registrant may visit the registry provider's website and login to the registrant's registry using the login information created in block 1310. Upon login, the server may provide registry information to the registrant in one or more webpages. The registry information may display items already added to the registry, and may further display recommendations provided by the selected individuals, including any message regarding the recommendation. The registry information may also identify each selected individual recommending an item and the social source or sources associated with the individual. The registrant may choose to accept, ignore, or comment on the recommended items. Accepting the recommended item or items may result in the addition of the item to the registry by the server. Ignoring the recommended item may result in removal of the item without addition to the registry by the server. Commenting on an item may result in a message being transmitted by the server to the recommending individual at one or more social sources associated with the individual. The message may include a registrant's question or comment regarding the recommended item.

Once the registry is populated with the items selected by the registrant or recommended by one or more individuals, the registrant may choose to publish the registry. The server may then make the registrant's registry generally available at the website. At this time, invitees to the registrant's event may then lookup the published registry at the registry provider's website (e.g., by entering the registrants name and date of event), and then browse, select, and purchase one or more items from the registry for the registrant. The process then ends in block 1340.

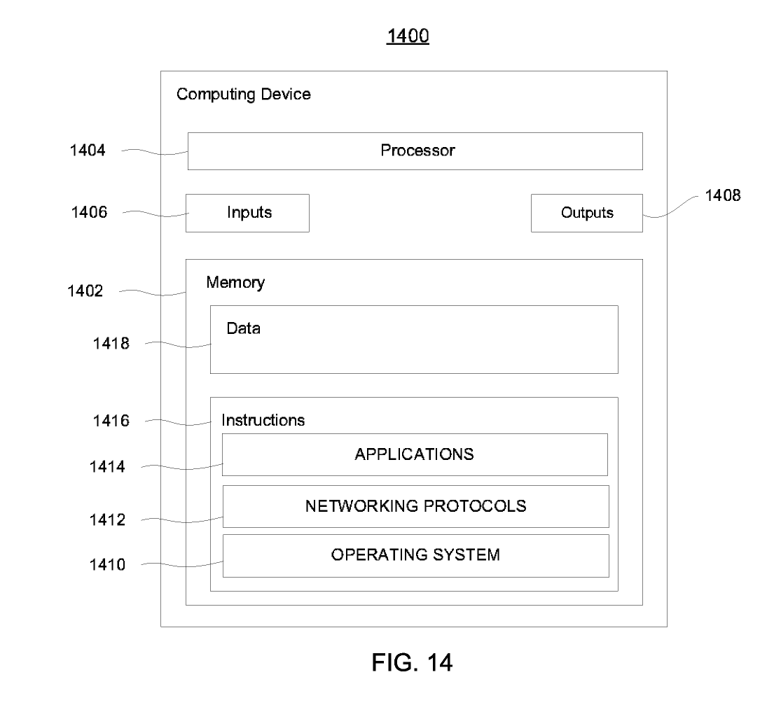

FIG. 14 illustrates one example of a computing device 1400 for implementing various aspects of the process described in FIG. 13. In one embodiment, the registry server 102, the consumer devices 104, and the social servers 106 may each be configured with all or some of the components of the computing device 1400 described below. As shown in the figure, the computing device 1400 may include a memory 1402 for storing registry information and a processor 1404 to receive, process, and transmit the registry information to other computing devices over the electronic network 110. The computing device 1400 may also include (or be interconnected with) various input peripherals 1406 and output peripherals 1408 for respectively entering information into the computing device and for outputting information from the computing device. Examples of such input/output peripherals include, without limitation, a keyboard, a display, a printer, one or more networking cards, etc. The computing device 1400 may further include other components (which may be implemented in hardware, software, or a combination of both) that are typically provided in computing devices, such as an operating system 1410 for managing the operation of the computing device and one or more networking protocols 1412 for enabling communication between various computing devices 1400 over the electronic network 108 (e.g., the Internet or a local area network). The computing device 1400 may also include one or more executable applications, programs, or scripts 1414, which, upon execution by the processor 1404, may configure the computing device 1400 to provide functionality in accordance with various aspects of the process described above.

Memory 1402 may store information accessible by processor 1404, including instructions 1416 that may be executed by the processor and information or data 1418 that may be stored, retrieved, and processed by the processor. The memory 1402 may be of any type or combination of memory capable of storing information accessible by the processor 1404, such as a hard-drive, memory card, ROM, RAM, DVD, CD-ROM, write-capable, and read-only memories. The processor 1404 may be any commercially available processor, such as a processor from Intel Corporation or Advanced Micro Devices. Alternatively, in one aspect the processor 1404 may be a dedicated controller such as an ASIC that is hardware configured to function in a manner consistent with various aspects described above.

The instructions 1416 executed by the processor 1404 may be any set of instructions to be executed directly (such as machine code) or indirectly (such as scripts) by the processor. In this regard, the terms “instruction,” “step”, “process”, “function” and “method” will be understood to be interchangeable in the disclosure. The instructions may be stored in object code format for direct processing by the processor 1404, or in any other computer language including scripts or collections of independent source code modules that are interpreted on demand or compiled in advance.

The data 1418 may be retrieved, stored or modified by processor 1404 in accordance with the instructions 1416. For instance, although the system and method is not limited by any particular data structure, the data can be stored in computer registers, in a relational database as a table having a plurality of different fields and records, or XML documents. The data can also be formatted in any computer-readable format such as, but not limited to, binary values, ASCII or Unicode. Moreover, the data can comprise any information sufficient to identify the relevant information, such as numbers, descriptive text, proprietary codes, pointers, references to data stored in other memories (including other network locations) or information that is used by a function to calculate the relevant data.

While FIG. 1400 functionally illustrates the components of the computing device 1400 within the same block it will be understood that the components can housed externally or internally to the device. For example, the processor 1404 and memory 1402 may comprise multiple processors and memories that may or may not be stored within the same physical housing. In addition, some of the instructions and data may be stored on a removable medium such as a CD-ROM and others within a read only computer chip. Some or all of the instructions and data can be stored in a location physically remote from, yet still accessible by, the processor 1400. Similarly, the processor 1400 may comprise a collection of processors which may or may not operate in parallel.

Although aspects herein have been described with reference to particular embodiments, it is to be understood that these embodiments are merely illustrative of the principles and applications of the present disclosure. It is therefore to be understood that numerous modifications can be made to the illustrative embodiments and that other arrangements can be devised without departing from the spirit and scope of the disclosure.

1. A method for soliciting recommendation of items for inclusion in a gift registry for a registrant, the method comprising:
receiving, information over an electronic network identifying a source associated with the registrant;
determining, using a processor, one or more individuals associated with the registrant at the source identified by the information; and,
transmitting, over the electronic network, an invitation to the source to provide recommendations for one or more items for inclusion in the gift registry to at least one individual selected from the one or more individuals associated with the registrant.

2. The method of claim 1, further comprising:
receiving, over the electronic network, at least one recommendation for an item selected by the at least one individual in response to the invitation; and,
saving, in a database, the recommendation for the item selected by the at least one individual for presentation to the registrant.

3. The method of claim 2, further comprising:
presenting, to the registrant on a display, the recommendation for the item selected by the at least one individual;
receiving, over the electronic network, an indication from the registrant to add the item selected by the at least one individual to the registry, and, adding the item selected by the at least one individual to the registry for the registrant.

4. The method of claim 2, further comprising:
presenting, to the registrant on a display, the recommendation for the item selected by the at least one individual for further action by the registrant;
receiving an indication from the registrant to request additional information regarding the item selected by the at least one individual; and,
transmitting a message at the source to the at least one individual requesting additional information regarding the item selected by the at least one individual.

5. The method of claim 1, wherein the source comprises an email account, and the step of determining the one or more individuals socially associated with the registrant further comprises determining, using the processor, one or more contacts associated with the registrant at the email account.

6. The method of claim 1, wherein the source comprises a social media network, and the step of determining the one or more individuals socially associated with the registrant further comprises determining, using the processor, one or more social connections associated with the registrant at the social media network.

7. The method of claim 1, wherein the source comprises a consumer device, and the step of determining the one or more individuals socially associated with the registrant further comprises determining, using the processor, one or more contacts associated with the registrant from data associated with an application stored on the consumer device.

8. The method of claim 1, wherein receiving the information over the electronic network further comprises receiving login information regarding the source associated with the registrant.

9. The method of claim 1, wherein the one or more individuals associated with the registrant at the source identified by the information are determined automatically.

10. The method of claim 1, wherein determining the one or more individuals associated with the registrant further comprises automatically determining a relationship between the one or more individuals and the registrant.

11. A method for soliciting recommendation of items for inclusion in a first gift registry for a first registrant and a second gift registry for a second registrant, the method comprising:
receiving, information over an electronic network identifying a source associated with the first registrant and the second registrant;
determining, using a processor, an individual associated with the first registrant and the second registrant at the source identified by the information; and,
transmitting, over the electronic network, an invitation to the selected individual to provide one or more item recommendations for inclusion in the first gift registry and the second gift registry;
receiving, over the electronic network, at least one item recommendation selected by the individual for inclusion in the first gift registry and the second gift registry in response to the invitation;
saving, in a database, the at least one item recommendation selected by the individual in the first gift registry for presentation to the first registrant; and,
saving, in the database, the at least one item recommendation selected by the individual in the second gift registry for presentation to the second registrant.

12. A gift registry system for managing a gift registry of a registrant, the gift registry system comprising:
a processor;
a memory storing one or more instructions executable by the processor, the one or more instructions, when executed by the processor, configuring the processor to:
identify a source including information regarding at least one individual connected with the registrant of the gift registry at the source;
automatically determine the at least one individual connected with the registrant based on the information obtained from the source; and,
transmit an invitation to the at least one individual connected with the registrant based on the information obtained from the source, the invitation including a request to the at least one individual to provide recommendations for items for inclusion in the gift registry for the registrant.

13. The system of claim 12, wherein the invitation includes a selectable link to a registry provider's website hosting one or more webpages including information regarding one or more items selectable by the at least one individual for recommendation for inclusion in the gift registry of the registrant.

14. The system of claim 13, wherein the processor is further configured to:
receive, upon selection of the selectable link included in the invitation, information identifying the at least one individual and the gift registry of the registrant.

15. The system of claim 12, wherein the processor is further configured to:
receive, at least one recommendation for an item for inclusion in the gift registry, the recommended item being selected by the at least one individual in response to the invitation;
display information regarding the recommended item to the registrant including an option to accept, reject or ignore the recommended item;
receive an indication from the registrant to accept the recommended item selected by the at least one individual to the registry, and,
add the recommended item selected by the at least one individual to the registry upon acceptance of the recommended item by the registrant.

16. The system of claim 12, wherein the source is an email account and the processor is further configured to:
transmit the invitation to the at least one individual by transmitting an email including the invitation to an email address of the at least one individual, the email address of the at least one individual being automatically determined based on the information obtained from the email account.

17. The system of claim 12, wherein the source is a social media network, and the processor is further configure to:
transmit the invitation to the at least one individual by transmitting a social media message including the invitation to a social media account of the at least one individual at the social media network, the social media account of the at least one individual being automatically determined based on the information obtained from the social media network.

18. A method for processing recommendations for items for inclusion in a gift registry associated with a registrant, the method comprising:
receiving information regarding one or more individuals selected by the registrant to provide recommendations for items for inclusion the gift registry;
receiving, from a given individual, a recommendation for an item for inclusion in the gift registry;
receiving information identifying the given individual providing the recommendation;
comparing the information identifying the given individual with the information regarding the one or more individuals selected by the registrant; and,
when a comparison result from the comparing step indicates that the given individual is one of the one or more individuals selected by the registrant, storing information regarding the item recommended by the given individual in association with the gift registry for presentment to the registrant.

19. The method of claim 18, further comprising:
presenting, to the registrant, the information regarding the item recommended by the given individual;
receiving an indication from the registrant indicating acceptance of the item recommended by the given individual; and,
adding the item recommended by the given individual to the gift registry associated with the registrant.
